(19) United States
(12) Patent Application Publication
(10) Pub. No.: US 2009/0025066 A1
(43) Pub. Date: Jan. 22, 2009

(54) SYSTEMS AND METHODS FOR FIRST AND SECOND PARTY AUTHENTICATION

(75) Inventors: Igal Roytblat, Richmond Hill (CA); Avraham Elarar, Montreal (CA); Moshe Ben-Shlomo, Vancouver (CA)

Correspondence Address: SEED INTELLECTUAL PROPERTY LAW GROUP PLLC, 701 FIFTH AVE, SUITE 5400, SEATTLE, WA, 98104, US

(73) Assignee: PROTECTIA CORPORATION, Montreal (CA)

(21) Appl. No.: 11/779,060

(22) Filed: Jul. 17, 2007

(51) Int. Cl. H04L 9/32

(52) U.S. Cl. 726/5

(57) ABSTRACT

First and second parties may be authenticated. After generating a challenge to the first party, two responses are received via the first party based on the challenge and two different keys. Two responses are also generated, and compared against the received responses. If the respective responses are verified, a confirmation is generated.

### BACKGROUND

1. Technical Field

This description generally relates to the field of authentication, and more particularly to authenticating a party coupled to a security device.

2. Description of the Related Art

Many service providers, such as banks and other financial institutions, stores and online gambling web sites, offer consumers the opportunity to conduct business online. These service providers require a reliable means of identifying consumers and authenticating their identity prior to allowing them to make costly expenditures or investments, and prior to allowing them access to private or confidential information.

Typically, service providers have required that consumers enter a login name and password for authentication purposes. The login name and password may be provided to the consumer by the service provider or may be created by the consumer, but, in either case, the consumer must remember this login name and password for each service provider with whom he or she has an account.

The consumer and service provider must therefore choose between a long and complex login name and password combination that is very difficult to guess but equally difficult for the consumer to remember, and a shorter, simpler login name and password combination that is easier to crack and easier for the consumer to remember. If the former approach is taken, the consumer may need to store a number of complex login names and passwords in a single repository to facilitate access to the consumer's accounts. For example, the consumer may keep a hard copy of his or her login names and passwords (e.g., in a wallet) or may save these login names and passwords on a single computer and risk having someone access that computer (in-person or remotely) and thereby gain access to all of the consumer's accounts. If the consumer uses a simpler login name and password combination, the consumer's accounts are vulnerable to a basic password guessing scheme (e.g., a dictionary attack) targeting the consumer's service providers.

The security of a consumer's accounts is also threatened by another type of internet fraud—phishing. Phishing schemes begin with fraudulent communications to consumers from malicious “hackers,” wherein the hackers pretend to be the consumers' service providers requesting updated information. Consumers are often directed to fake web sites (programmed to look like the service provider's actual website), where they are then prompted to enter their login names and passwords. These malicious hackers thus obtain login names and passwords by simply asking for them.

Yet another threat to the consumer's security may stem from fraud within the providers' organizations, where individuals that have access to the providers' computer systems may abuse those rights and gather consumer information or break into the consumer's accounts.

However accomplished, if a malicious hacker or other individual is able to acquire the consumer's login name and password information, then the consumer's accounts are compromised, and the hacker is typically able to access these accounts from anywhere in the world without the consumer learning of this illicit access.

New approaches to limiting potential access to consumers' electronic accounts on service providers are highly desirable.

### BRIEF SUMMARY

In one embodiment, a method of authentication between a first party and a second party comprises: generating a challenge to a first party system; receiving a first response via the first party system, the first received response produced on a first party side of a network connection, the first received response based on the challenge and a most recent first party key stored on a memory of a first party security device communicatively coupled to the first party system; receiving a second response via the first party system, the second received response produced on the first party side of the network connection, the second received response based on the challenge and a second party key stored on the memory of the first party security device, the second party key provided to the first party security device from a second party side of the network connection; generating a first response based on the challenge and a most recent first party key stored on the second party side of the network connection; generating a second response based on the challenge and a second party key stored on the second party side of the network connection; verifying the first received response against the first generated response; verifying the second received response against the second generated response; and generating a confirmation in response to a successful verification of both the first and the second received responses.

In another embodiment, another method of authentication between a first party and a second party comprises: receiving a challenge at a first party system from a second party side of a network connection; producing a first response to the challenge on a first party side of the network connection, the first response based on the challenge and a most recent first party key stored on a memory of a first party security device communicatively coupled to the first party system; producing a second response to the challenge on the first party side of the network connection, the second response based on the challenge and a second party key stored on the memory of the first party security device, the second party key provided to the first party security device from the second party side of the network connection; receiving a confirmation code from the second party side of the network connection, the received confirmation code based on the first response and a most recent first party key stored on the second party side of the network connection as provided by a trusted third party; generating a first confirmation code based on the first response and the most recent first party key stored on the memory of the first party security device; and verifying the received confirmation code against the first generated confirmation code.

In another embodiment, a computer-readable medium is disclosed that stores instructions that cause a computer to perform authentication between a first party and a second party, by: generating a challenge to a first party system; receiving a first response via the first party system, the first received response produced on a first party side of a network connection, the first received response based on the challenge and a most recent first party key stored on a memory of a first party security device communicatively coupled to the first party system; receiving a second response via the first party system, the second received response produced on the first party side of the network connection, the second received response based on the challenge and a second party key stored on the memory of the first party security device, the second party key provided to the first party security device from a second party side of the network connection; generating a first response based on the challenge and a most recent first party key stored on the second party side of the network connection; generating a second response based on the challenge and a second party key stored on the second party side of the network connection; verifying the first received response against the first generated response; verifying the second received response against the second generated response; and generating a confirmation in response to a successful verification of both the first and the second received responses.

In another embodiment, another computer-readable medium is disclosed that stores instructions that cause a computer to perform authentication between a first party and a second party, by: receiving a challenge at a first party system from a second party side of a network connection; producing a first response to the challenge on a first party side of the network connection, the first response based on the challenge and a most recent first party key stored on a memory of a first party security device communicatively coupled to the first party system; producing a second response to the challenge on the first party side of the network connection, the second response based on the challenge and a second party key stored on the memory of the first party security device, the second party key provided to the first party security device from the second party side of the network connection; receiving a confirmation code from the second party side of the network connection, the received confirmation code based on the first response and a most recent first party key stored on the second party side of the network connection as provided by a trusted third party; generating a first confirmation code based on the first response and the most recent first party key stored on the memory of the first party security device; and verifying the received confirmation code against the first generated confirmation code.

In yet another embodiment, a system that performs authentication between a first party and a second party comprises: at least one processor that executes instructions; and a computer-readable memory that stores instructions that cause the at least one processor to perform authentication, by: generating a challenge to a first party system; receiving a first response via the first party system, the first received response produced on a first party side of a network connection, the first received response based on the challenge and a most recent first party key stored on a memory of a first party security device communicatively coupled to the first party system; receiving a second response via the first party system, the second received response produced on the first party side of the network connection, the second received response based on the challenge and a second party key stored on the memory of the first party security device, the second party key provided to the first party security device from a second party side of the network connection; generating a first response based on the challenge and a most recent first party key stored on the second party side of the network connection; generating a second response based on the challenge and a second party key stored on the second party side of the network connection; verifying the first received response against the first generated response; verifying the second received response against the second generated response; and generating a confirmation in response to a successful verification of both the first and the second received responses.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of a networked authentication environment, including a number of users, a number of providers, and at least one trusted third party, according to one illustrated embodiment.

FIG. 2 is a schematic diagram of a user side of a network connection, including a computing system communicatively coupled to a user security device, according to one illustrated embodiment.

FIGS. 3A and 3B are flow diagrams illustrating a portion of a method of authentication according to one illustrated embodiment, in which FIG. 3A illustrates acts taken on a user side of a network connection and FIG. 3B illustrates acts taken on a provider side of the network connection.

FIGS. 4A and 4B are flow diagrams illustrating a subsequent portion of the method of authentication, in which FIG. 4A illustrates acts taken on the user side of the network connection and FIG. 4B illustrates acts taken on the provider side of the network connection.

FIGS. 5A and 5B are flow diagrams of a method of registering a user and a service provider with a trusted third party, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with servers, networks, computers, memory devices and/or displays have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

### Description of an Example Networked Authentication Environment

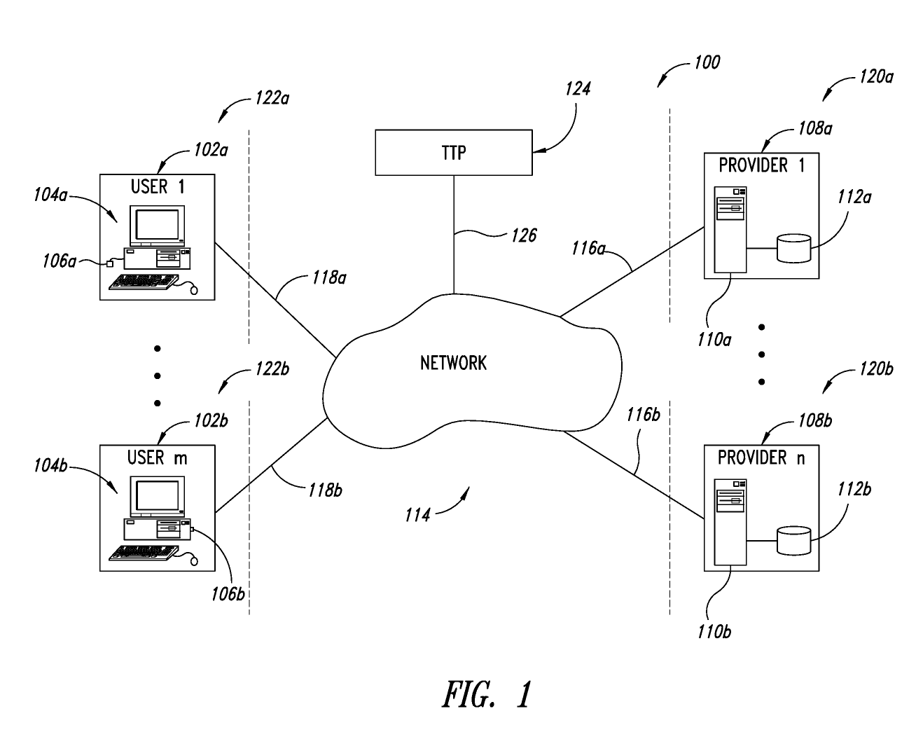

FIG. 1 shows a networked authentication environment 100 according to one illustrated embodiment.

The networked authentication environment 100 includes a plurality of users 102a, 102b (collectively 102) coupled through a network 114 to a plurality of providers 108a, 108b (collectively 108). In one embodiment, the providers 108 provide services to the users 102 via the network, and an authentication process is therefore used to ensure that user data is being shared appropriately. A trusted third party 124 (“TTP”) may facilitate the authentication process between the providers 108 and the users 102 and is coupled through the network 114 to these parties.

As illustrated and described herein, the providers 108 may provide any of a variety of services over a network such as the Internet. For example, each provider 108 may be a bank, a financial institution, an online gambling website, an online storefront, etc. In turn, the users 102 taking advantage of these providers' services may be bank, financial institution, online gambling or storefront customers. In another embodiment, the providers 108 may represent local intranets, to which users 102, representing employees, desire remote access via the Internet. In yet another embodiment, the providers 108 may simply be other users with whom the users 102 would like to set up secure communications. In yet another embodiment, the providers 108 may represent government agencies with whom the users 102 (representing other government agencies) would like to establish authenticated communication sessions.

The methods illustrated and described with reference to the following figures are not limited to particular providers and users. It may be understood that the user and provider may represent any first and second party that authenticate each other. Indeed, the user need not include a human being, and the provider need not be a business entity. In other embodiments, for example, the methods described herein may be used to facilitate authentication between first and second computing systems automatically authenticating each other.

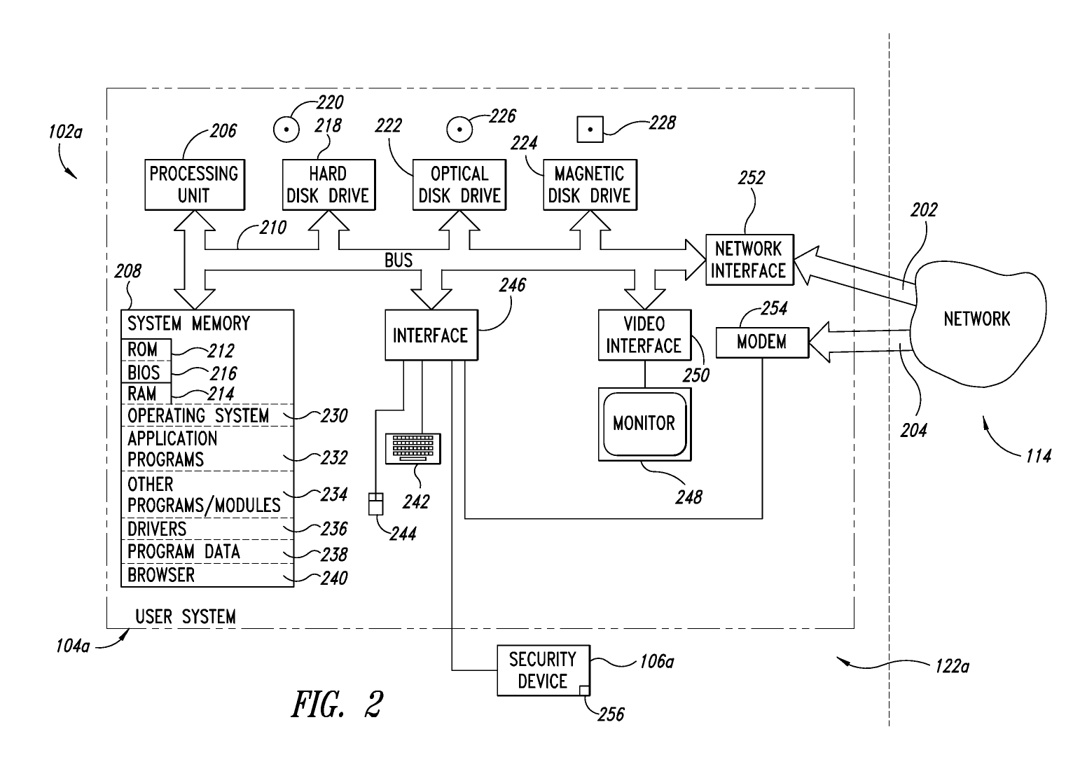

In one embodiment, each of the users 102 has a user computing system (“user system”) 104 communicatively coupled to a respective user security device 106. An example user system 104a and user security device 106a are discussed in greater detail below with reference to FIG. 2.

In one embodiment, each of the providers 108 has a provider computing system (“provider system”) 110 and a gatekeeper module 112. Provider system 110a includes at least one processor that executes instructions and a computer-readable memory that stores instructions to cause the processor to perform certain functions. In one embodiment, the provider system 110a may comprise one or more networked computer servers, and the gatekeeper module 112a may be implemented as a software module running on these servers or may be implemented on its own machine. Further implementation details of provider system 110a and gatekeeper module 112a are discussed below with reference to FIG. 2.

As illustrated, network 114 couples the providers 108 to the users 102. Associated with the providers 108 are respective provider logical connections 116a, 116b (collectively 116) connecting the providers 108 to the network 114, and associated with the users 102 are respective user logical connections 118a, 118b (collectively 118) connecting the users 102 to the network 114. Thus, as illustrated, a network connection may exist between the provider 108a and the user 102a, including the provider logical connection 116a, the user logical connection 118a and the network 114 connecting these logical connections. In one embodiment, each provider 108 is capable of forming network connections with a plurality of users 102 simultaneously, and similarly, each user 102 is capable of forming network connections with a plurality of providers 108 simultaneously.

The illustrated network 114 and logical connections 116, 118 may comprise any of a variety of networks and associated hardware and/or software. The network 114 may comprise a wired or wireless enterprise-wide computer network, intranet, extranet, or the Internet. Other embodiments may be implemented in other types of communication networks, including telecommunications networks, cellular networks, paging networks, and other mobile networks. The illustrated logical connections may be wired or wireless and may employ any of a variety of network protocols to communicatively couple to the network 114.

At the terminus of each logical connection 116, 118, a dashed line is shown in FIG. 1, representing a respective side of a network connection. For example, referring to the network connection formed between the provider 108a and the user 102a, the provider side of the network connection is illustrated by callout 120a, and the user side of the network connection is illustrated by callout 122a. Thus, the provider system 110a and the gatekeeper module 112a may be found on the provider side of the network connection 120a, while the user system 104a and the user security device 106a may be found on the user side of the network connection 122a.

In one embodiment, all of the computing devices on one side of a network connection are serviced by a single logical connection. For example, the user system 104a and the user security device 106a communicatively coupled to that user system 104a may be coupled by a single logical connection 118a to the network 114. This is a situation that may be found in home computing environments, with multiple home computers logically connected to an ISP via a shared modem. In other embodiments, the illustrated logical connections may be understood to include multiple logical connections, and these logical connections couple one side of a network connection to the network 114. For example, the provider side of the network connection 120a may include a plurality of web servers having a plurality of publicly-addressable IP addresses.

On the provider side of the network connection 120a, the networked computing devices, including the provider system 110a, may communicate with each other via an internal network or some other communication means without having communications routed through the network 114. Similarly, on the user side of the network connection 122a, the networked computing devices, including the user system 104a, may communicate with each other via an internal network or some other communication means without having communications routed through the larger network.

The trusted third party 124 illustrated in FIG. 1 may comprise one or more networked servers and may have hardware configured similarly to that of the providers 108. As is explained further below, the trusted third party 124 may facilitate the process of authentication between the users 102 and the providers 108, although, in other embodiments, a trusted third party 124 may not be necessary.

### Discussion of a Suitable Computing Environment

FIG. 2 and the following discussion provide a brief, general description of a suitable user system 104a and user security device 106a in which the various illustrated embodiments can be implemented. Although not required, the embodiments will be described in the general context of computer-executable instructions, such as program application modules, objects, or macros being executed by a computer. Those skilled in the relevant art will appreciate that the illustrated embodiments as well as other embodiments can be practiced with other computer system configurations, including handheld devices, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

FIG. 2 shows the user system 104a located on the user side of a network connection 122a. The user system 104a is coupled by one or more communications channels/logical connections 202, 204 to the network 114. Either of these logical connections 202, 204 may serve as the logical connection 118a illustrated in FIG. 1 communicatively coupling the user system 104a to the network 114.

The user system 104a may take the form of a conventional PC, which includes a processing unit 206, a system memory 208 and a system bus 210 that couples various system components including the system memory 208 to the processing unit 206. The user system 104a will at times be referred to in the singular herein, but this is not intended to limit the embodiments to a single user system, since in certain embodiments, there will be more than one user system or other networked computing device involved. Non-limiting examples of commercially available systems include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processing unit 206 may be any logic processing unit, such as one or more central processing units (CPUs), digital signal processors (DSPs), application-specific integrated circuits (ASICs), field programmable gate arrays (FPGAs), etc. Unless described otherwise, the construction and operation of the various blocks shown in FIG. 2 are of conventional design. As a result, such blocks need not be described in further detail herein, as they will be understood by those skilled in the relevant art.

The system bus 210 can employ any known bus structures or architectures, including a memory bus with memory controller, a peripheral bus, and a local bus. The system memory 208 includes read-only memory (“ROM”) 212 and random access memory (“RAM”) 214. A basic input/output system (“BIOS”) 216, which can form part of the ROM 212, contains basic routines that help transfer information between elements within the user system 104a, such as during start-up.

The user system 104a also includes a hard disk drive 218 for reading from and writing to a hard disk 220, and an optical disk drive 222 and a magnetic disk drive 224 for reading from and writing to removable optical disks 226 and magnetic disks 228, respectively. The optical disk 226 can be a CD or a DVD, while the magnetic disk 228 can be a magnetic floppy disk or diskette. The hard disk drive 218, optical disk drive 222 and magnetic disk drive 224 communicate with the processing unit 206 via the system bus 210. The hard disk drive 218, optical disk drive 222 and magnetic disk drive 224 may include interfaces or controllers (not shown) coupled between such drives and the system bus 210, as is known by those skilled in the relevant art. The drives 218, 222, 224, and their associated computer-readable media 220, 226, 228, provide nonvolatile storage of computer-readable instructions, data structures, program modules and other data for the user system 104a. Although the depicted user system 104a employs hard disk 220, optical disk 226 and magnetic disk 228, those skilled in the relevant art will appreciate that other types of computer-readable media that can store data accessible by a computer may be employed, such as magnetic cassettes, flash memory cards, Bernoulli cartridges, RAMs, ROMs, smart cards, etc.

Program modules can be stored in the system memory 208, such as an operating system 230, one or more application programs 232, other programs or modules 234, drivers 236 and program data 238. The system memory 208 may also include communications programs, for example a web client or browser 240 for permitting the user system 104a to access and exchange data with sources such as web sites on the Internet, corporate intranets, or other networks as described below. The browser 240 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of web clients or browsers are commercially available such as those from Mozilla Corporation of California and Microsoft of Washington.

While shown in FIG. 2 as being stored in the system memory 208, the operating system 230, application programs 232, other programs/modules 234, drivers 236, program data 238 and browser 240 can be stored on the hard disk 220 of the hard disk drive 218, the optical disk 226 of the optical disk drive 222 and/or the magnetic disk 228 of the magnetic disk drive 224. A user can enter commands and information into the user system 104a through input devices such as a touch screen or keyboard 242 and/or a pointing device such as a mouse 244. Other input devices can include a microphone, joystick, game pad, tablet, scanner, biometric scanning device, etc. These and other input devices are connected to the processing unit 206 through an interface 246 such as a universal serial bus (“USB”) interface that couples to the system bus 210, although other interfaces such as a parallel port, a game port or a wireless interface or a serial port may be used. A monitor 248 or other display device is coupled to the system bus 210 via a video interface 250, such as a video adapter. Although not shown, the user system 104a can include other output devices, such as speakers, printers, etc.

The user system 104a operates in a networked environment using one or both of the logical connections 202, 204 to communicate with one or more remote computers, servers and/or devices through the network 114. These logical connections may facilitate any known method of permitting computers to communicate, such as through one or more LANs and/or WANs, such as the Internet. Such networking environments are well known in wired and wireless enterprise-wide computer networks, intranets, extranets, and the Internet. Other embodiments include other types of communication networks including telecommunications networks, cellular networks, paging networks, and other mobile networks.

When used in a WAN networking environment, the user system 104a may include a modem 254 for establishing communications over the WAN 204. Alternatively, another device, such as the network interface 252 (communicatively linked to the system bus 210), may be used for establishing communications over the WAN 202. The modem 254 is shown in FIG. 2 as communicatively linked between the interface 246 and the WAN 204. In a networked environment, program modules, application programs, or data, or portions thereof, can be stored in a server computing system (not shown). Those skilled in the relevant art will recognize that the network connections shown in FIG. 2 are only some examples of ways of establishing communications between computers, and other connections may be used, including wirelessly.

On the user side of the network connection 122a, as illustrated in FIGS. 1 and 2, there is also a user security device 106a communicatively coupled with the user system 104a. In one embodiment, the user security device 106a is coupled to the system bus 210 through the interface 246 and is thereby communicatively coupled to the user system 104a.

The user security device 106a may include a digital memory 256 for data storage. In certain embodiments, the user security device 106a comprises a portable memory device, or “removable storage,” that is adapted to be moved from computing system to computing system. For example, the user security device 106a may comprise a USB memory device, such as a USB flash drive including flash memory for storage or a USB hard disk drive including hard disks for storage. The user security device 106a may also be chosen from among other portable digital devices having memory as well, including: personal digital assistants (PDAs), cell phones, digital cameras, etc. In still other embodiments, the user security device 106a may be a hard disk drive like the hard disk drive 218 illustrated in FIG. 2, and may be relatively permanently coupled to the user system 104a.

In the illustrated embodiment, the user security device 106a is merely a storage device. In other words, although complex algorithms may be performed in the user security device 106a in order to store, maintain and communicate stored data, the principal function of the user security device 106a is to store and communicate such stored data. A USB flash drive is an example of such a storage device. In alternative embodiments, the user security device may include more “intelligence.” In such embodiments, the user system 104a may issue requests to the user security device asking that some function be performed using data stored thereon, and the user security device may be capable of returning the result of that function. A subscriber identity module (SIM), such as those employed in GSM cellular phones, is an example of such a user security device. In such alternative embodiments, the user security device may include many of the same components illustrated in FIG. 2 as included within the user system 104a.

As will be described in greater detail below, the user security device 106a may be configured to facilitate the authentication of the user system 104a with one or more service providers 108. To improve security, the user security device 106a may be accessible only by a user having the correct password. This access restriction may be performed in a number of ways well known to those of skill in the art. For example, the data may be stored on the user security device 106a in an encrypted format, and the user security device 106a may only be capable of decrypting the data with an appropriate password entered by the user. In another embodiment, internal circuitry in the user security device 106a may prevent access to the data stored thereon without entry of an appropriate password. In still another embodiment, the operating system 230 or driver 236 for the user security device 106a may prevent access thereto without entry of an appropriate password. It may be understood that certain access limitations are more or less secure and may be viable for some but not other applications.

The computing systems of the trusted third party 124 and the providers 108 may be configured in a manner similar to that shown in FIG. 2. For example, each of the trusted third party 124 and the provider system 110a may comprise at least one server having a system memory, a processing unit, a system bus, interfaces and one or more storage devices. The at least one server may be coupled to the network 114, as illustrated in FIG. 1, via at least one logical connection. A gatekeeper module 112a (implemented in hardware or in software) may also be provided on the provider side of the network connection 120a. In one embodiment, the gatekeeper module 112a is provided by a third party (such as the trusted third party 124) in order to facilitate the authentication process between the users 102 and providers 108.

As discussed above, the gatekeeper module 112a may simply be an application program, like those illustrated in FIG. 2, loaded in the system memory of the provider system 110a. Alternatively, the gatekeeper module 112a may comprise separate server hardware networked with the provider system 110a. This separate server hardware may communicate directly with the network 114 via a distinct logical connection, or may be communicatively coupled with the network 114 through the provider system 110a and the illustrated provider logical connection 116a.

### Discussion of a Method of Authentication According to One Embodiment

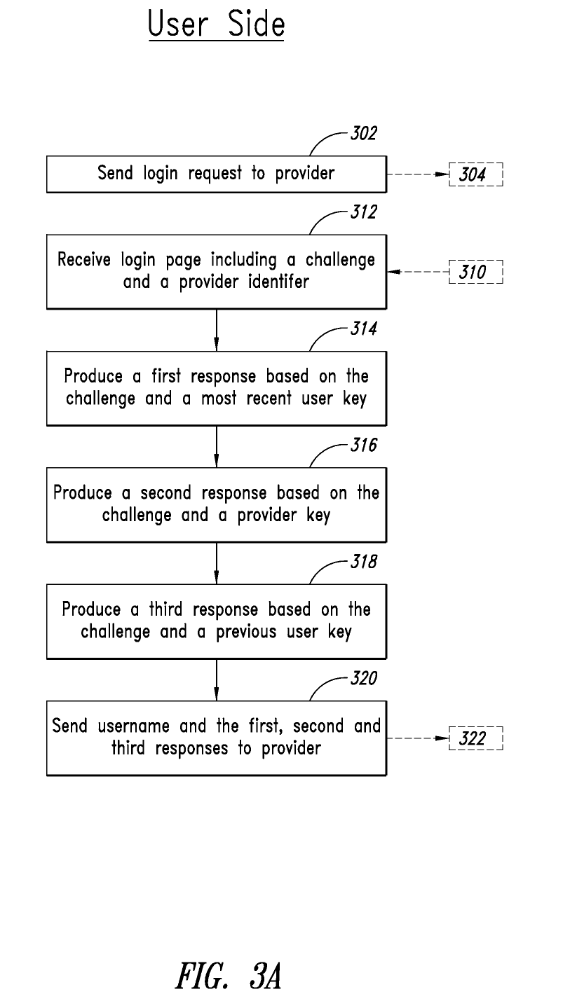

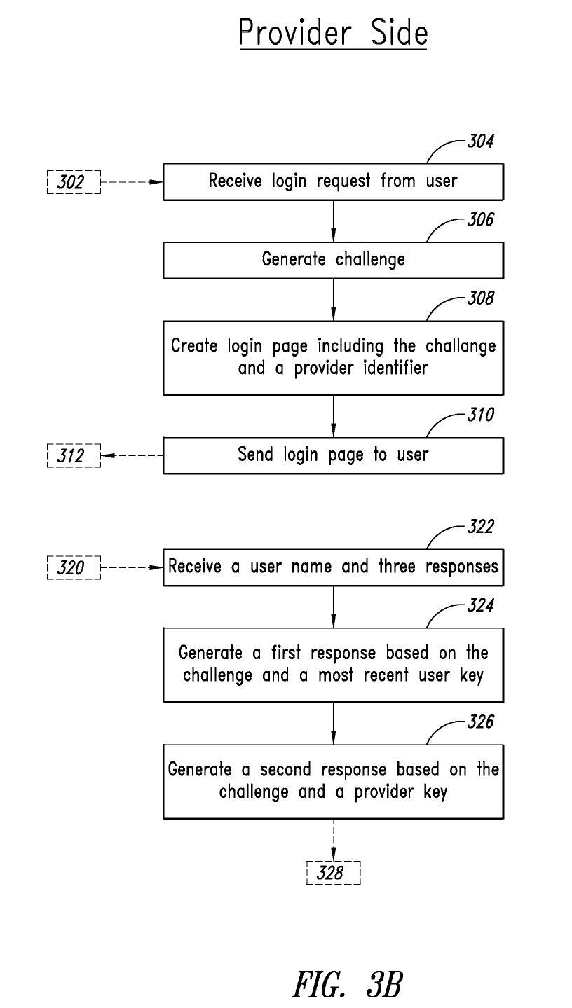

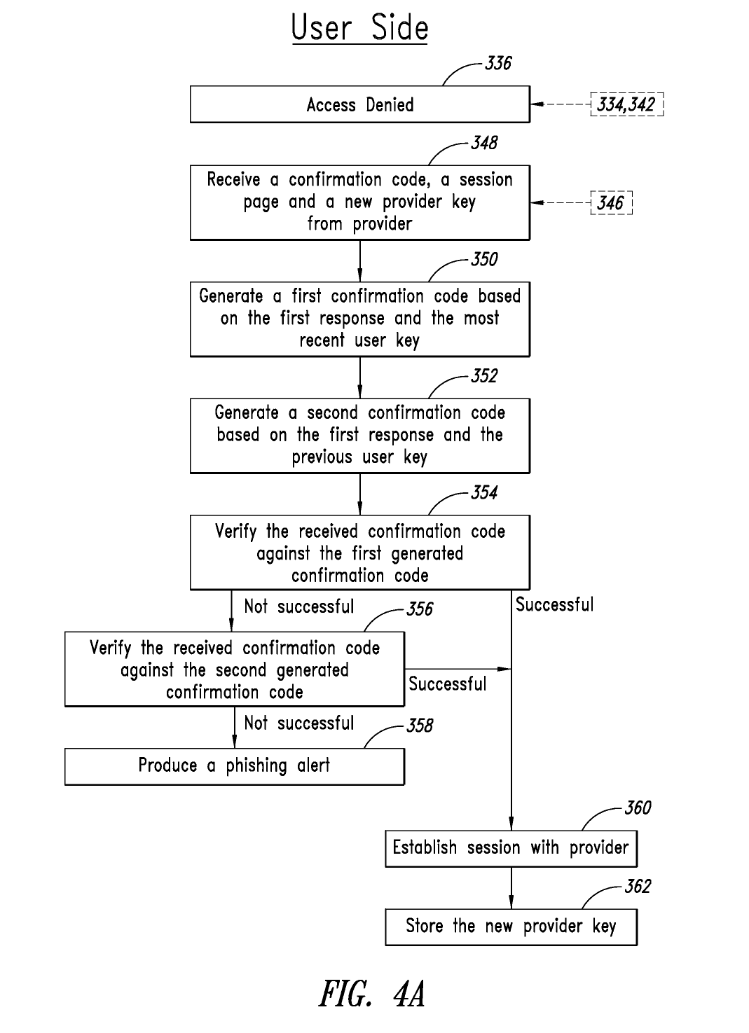

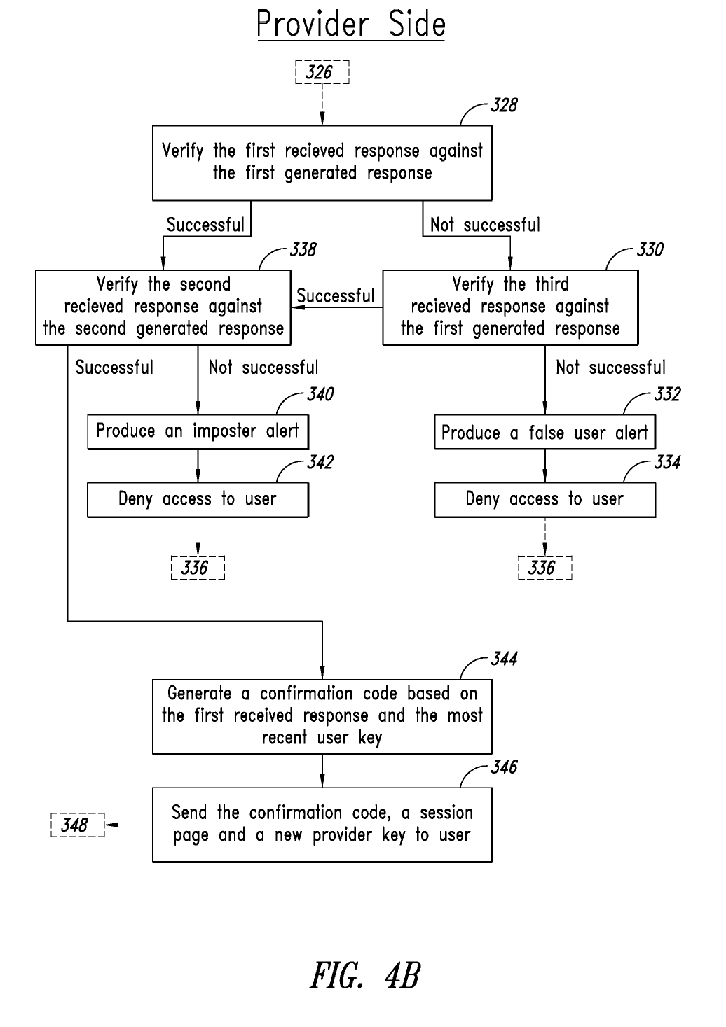

FIGS. 3A, 3B, 4A and 4B illustrate a flow diagram for a method of authentication according to one embodiment, in which FIGS. 3A and 4A illustrate acts taken on a user side of a network connection and FIGS. 3B and 4B illustrate acts taken on a provider side of the network connection. This method will be discussed in the context of the user 102a and the provider 108a, which may also be referred to as the first and second parties, respectively. However, it may be understood that the acts disclosed herein may also be executed in different computing environments in accordance with the described method.

It may be further understood that when referring to the user side 122a, any of the computing systems or devices (including the user security device 106a) on the user side of the network connection 122a may perform the illustrated act. Similarly, when referring to the provider side 120a, any of the computing systems or devices (including the provider system 110a or the gatekeeper module 112a) on the provider side of the network connection 120a may perform the illustrated act. Furthermore, although certain acts are designated as occurring on the user side 122a and others on the provider side 120a, in other embodiments, the user and provider authentication roles may be reversed.

The method begins at 302, when the user side 122a sends a login request to the provider side 120a. In one embodiment, a user directs a browser 240 on the user system 104a to a web page hosted by the provider system 110a. This web page may include a login option, among other information. In another embodiment, another network protocol may be used by the user system 104a to make contact with the provider side 120a to attempt a login.

At 304, the provider side 120a receives the login request from the user side 122a. In one embodiment, the provider system 110a includes a web server, which receives the web page request from the user system 104a. In alternative embodiments, the gatekeeper module 112a or another computing system on the provider side 120a may receive the login request sent at 302.

At 306-310, the provider side 120a generates a challenge to the user system 104a. In one embodiment, the illustrated acts are performed in order to generate this challenge. In other embodiments, the provider system 110a may generate a challenge using a random number generator and forward it via any of a number of network protocols back to the user side 122a. In such an embodiment, web pages need not be exchanged between the provider side 120a and the user side 122a.

At 306, the provider side 120a generates the challenge. In one embodiment, the challenge comprises a string (e.g., a random string) on which the user side 122a will operate in order to authenticate itself. The challenge may be generated by a variety of methods. In one embodiment, the provider system 110a, upon receiving the login request, prompts the gatekeeper module 112a to generate a random challenge. The gatekeeper module 112a, which may comprise a random number generator, then generates the challenge and returns the challenge to the provider system 110a. In alternative embodiments, the provider system 110a may generate the challenge itself, without use of a gatekeeper module.

At 308, the provider side 120a creates a login page including the challenge and a provider identifier. The provider identifier may be any string or code uniquely identifying the provider 108a, and may be provided by the trusted third party 124. Each of the providers 108 is preferably associated with a unique provider identifier. The login page may comprise any markup language, such as HTML or XML, and the generated challenge and the provider identifier may be embedded therein. Any of a number of scripting and/or programming languages may be used to automatically generate such a login page.

At 310, the provider side 120a sends the login page to the user side 122a, preferably to the user system 104a. In one embodiment, the login page is sent via secure Hypertext Transfer Protocol (HTTPS). In other embodiments, other network protocols, such as unsecured HTTP, may be used to transfer the login page having embedded therein the challenge and the provider identifier.

At 312, the user side 122a receives the login page including the challenge and provider identifier. In one embodiment, in response to receipt of the login page, the browser 240 running on the user system 104a may prompt the user to plug in the user security device 106a (for example, if the user security device 106a is a removable storage device, such as a USB flash drive). Once the user system 104a and user security device 106a are communicatively coupled, the user may also be prompted to authenticate himself or herself in order to use the user security device 106a. For example, the user may need to enter a password using the keyboard 242 or mouse 244 of the user system 104a. Alternatively, the user system 104a may use biometric identification to authenticate the user, such as fingerprints, retinal scans, etc.

Once the user, the user system 104a, and the user security device 106a are properly coupled and authenticated, the browser 240 may forward the received challenge to the user security device 106a. In one embodiment, the user security device 106a may store the challenge for future use by the user system 104a. However, in other embodiments, the user security device 106a may itself perform algorithms based on the challenge.

At 314, the user side 122a produces a first response based on the challenge and a most recent user key. The user key may comprise a string of characters, randomly generated or generated according to a specific, secret algorithm. In one embodiment, the most recent user key is stored on the memory 256 of the user security device 106a. In those embodiments in which the user security device 106a is removable storage, the user may thereby be able to carry around the most recent user key with him or her from system to system without memorizing it. On the provider side 120a, the most recent user key may be stored on the provider system 110a or stored on or with the gatekeeper module 112a.

The most recent user key may be obtained in a variety of ways. In one embodiment, a trusted third party 124 is capable of creating network connections with both the user 102a and the provider 108a. In such an embodiment, the trusted third party 124 may periodically send user keys to both the user side 122a and the provider side 120a. Either the provider 108a or the user 102a, or both, may request that the trusted third party 124 update the user keys at a certain periodicity (daily, weekly, monthly, etc.). These user keys may be provided to the user side 122a and the provider side 120a by email, SMS text message, HTTPS or other network transfer protocols. In one embodiment, wherein the provider side 120a includes business information that an employee, i.e. the user, remotely accesses, this periodic updating of the user keys may prevent continued access by the user if the user should stop working for the provider.

In one embodiment, the user keys may not be delivered to the user 102a and the provider 108a simultaneously. Thus, a most recent user key stored on the user side 122a may not be the same as a most recent first user key stored on the provider side 120a. In another embodiment, even if the user keys are delivered simultaneously, either the user 102a or the provider 108a may take some quantity of time to update the most recent user key stored on their respective sides of the network connection. In yet another embodiment, the user keys may be generated on the user side 122a or on the provider side 120a and forwarded to the other authenticating party.

As indicated in 314, the user side 122a produces the first response based on the challenge and the most recent user key. In one embodiment, a driver associated with the user security device 106a, or another application program loaded on the user system 104a may be used to produce the first response. This application program and/or driver may have been received from the trusted third party 124 at an earlier time and includes an algorithm for producing responses. In one embodiment, the algorithm is chosen such that, even if a malicious hacker discovers the challenge, the most recent user key and the first response, that malicious hacker would not be able to readily produce a subsequent response based on a new challenge and a new user key. The application program and/or driver may be stored on the memory 256 of the user security device 106a, or may be stored on other media, such as the hard disks 220, optical disks 226 or magnetic disks 228 readable by the user system 104a.

In another embodiment, the user security device 106a may include software or firmware executable by the user security device 106a that includes the algorithm for producing the first response. In this embodiment, a processor in the user security device 106a may execute the algorithm, and the first response may then be passed on to the user system 104a.

At 316, a second response is produced on the user side 122a based on the challenge and a provider key. The provider key may comprise a string of characters, randomly generated or generated according to a specific, secret algorithm. In one embodiment, the provider key is stored on the memory 256 of the user security device 106a. In those embodiments in which the user security device 106a is removable storage, the user may thereby be able to carry around the provider key with him or her from system to system without memorizing it. On the provider side 120a, the provider key may be stored on the provider system 110a or stored on or with the gatekeeper module 112a.

The provider key may be obtained in a variety of ways. In one embodiment, the provider key is generated on the provider side 120a and provided directly to the user side 122a, and in turn to the user security device 106a, from time to time. The provider key may be generated by the gatekeeper module 112a in one embodiment, or by the provider system 110a in another. By generating the provider key on the provider side 120a, the authentication system may be made more secure because the trusted third party 124 does not have access to both the user keys and the provider keys. If a disgruntled employee at the trusted third party 124, for example, attempts to take advantage of the authentication system herein described, the employee would only have half the keys necessary to authenticate. In one embodiment, the authentication method may be considered “double blind,” as the trusted third party 124 does not have all of the information necessary to break into a user's account, and employees on the provider side 120a only have this information for a short time (e.g., until the user key is updated, as described at 314). Of course, in other embodiments, the trusted third party 124 may instead periodically send the provider keys to both the user side 122a and the provider side 120a.

The provider keys may be provided to the user side 122a by email, SMS text message, HTTPS or other network transfer protocols. As described later, in one embodiment the provider keys are provided by HTTPS during initiation of an authentication session between the user side 122a and the provider side 120a (as described below with reference to 346).

The provider keys may also be universal or unique to each user. If universal, the provider keys may be updated on a regular basis for all of the possible users. If unique, each user 102 may be provided with its own updated provider key for each new session. In such an embodiment, a user will only be authenticated if it has the correct provider key from its last session with the provider.

As indicated in 316, the user side 122a produces the second response based on the challenge and the provider key. This second response is preferably produced in a manner similar to that described with reference to the first response, although in some embodiments different methods may be used to produce the two responses.

At 318, the user side 122a produces a third response based on the challenge and a previous user key. As discussed above, in one embodiment, the trusted third party 124 periodically sends user keys to both the user side 122a and the provider side 120a. A history of these user keys may be stored on the user side 122a, and, in particular, on the memory 256 of the user security device 106a. As described herein, the history should include at least the most recent user key and the user key previous to this most recent one. Since the provider system 110a and the user security device 106a may not always have synchronized user keys, this stored history of user keys may enable authentication even if the two are not perfectly synchronized.

The third response is preferably produced in a manner similar to that described with reference to the first response.

At 320, the user side 122a sends a username and the first, second and third responses to the provider side 120a. In one embodiment, the browser 240 sends the username along with the first, second and third responses via HTTPS to the provider system 110a. The username may identify the information to which the user would like access on the provider system 110a (e.g., user-specific bank records), and may also enable the provider side 120a to identify which provider key was last provided to a particular user. Of course, in other embodiments, a username need not be used, and the user 102a may be identified in other ways, such as by IP address.

In one embodiment, the first, second and third responses are sent together to the provider side 120a, where they are received together. In other embodiments, only the first and second responses may be sent to the provider side 120a, and they may also be sent at different times.

At 322, the provider side 120a receives the username and the first, second and third responses from the user side 122a. In one embodiment, the provider system 110a receives the username and the first, second and third responses. For example, the provider system 110a may include a web server that receives the above information. In this embodiment, the provider system 110a itself may perform operations based on this information, or it may forward the username and received responses to the gatekeeper module 112a for further processing.

At 324, the provider side 120a generates a first response based on the challenge and a most recent user key stored on the provider side 120a. As discussed above, in one embodiment, the trusted third party 124 periodically sends user keys to both the user side 122a and the provider side 120a. On the provider side 120a, the most recent user key may be stored on the provider system 110a or stored on or with the gatekeeper module 112a.

In one embodiment, the gatekeeper module 112a generates the first response based on the challenge and the most recent user key stored on the provider side 120a. The gatekeeper module 112a may, for example, include an algorithm identical to that used on the user side 122a in acts 314-318. Alternatively, the provider system 110a may employ a similar algorithm to generate the first response.

At 326, the provider side 120a generates a second response based on the challenge and a provider key stored on the provider side 120a. As discussed above, in one embodiment, the provider key is generated on the provider side 120a and forwarded to the user side 122a. The provider key may be generated by the gatekeeper module 112a in one embodiment, or by the provider system 110a in another. On the provider side 120a, the provider key (whether it is a universal provider key or one unique to the user 102a) may be stored on the provider system 110a or stored on or with the gatekeeper module 112a.

In one embodiment, the second response is generated by the gatekeeper module 112a based on the challenge and the provider key stored on the provider side 120a. The gatekeeper module 112a may, for example, include an algorithm identical to that used on the user side 122a in acts 314-318. Alternatively, the provider system 110a may employ a similar algorithm to generate the second response.

Turning to FIGS. 4A and 4B, at 328, the provider side 120a verifies the first received response against the first generated response. In one embodiment, the gatekeeper module 112a generates the first and second responses on the provider side 120a and then forwards the first and second generated responses to the provider system 110a. The provider system 110a then verifies the first received response against the first generated response. The first received response may be successfully verified against the first generated response if the two responses are identical. In other embodiments, the gatekeeper module 112a may both generate the first and second responses as well as verify them. In still other embodiments, other methods for verifying the responses may be used.

If the first received response has not been successfully verified against the first generated response, at 330 the provider side 120a verifies the third received response against the first generated response in a manner similar to that described with respect to verification 328. The most recent user keys on the provider side 120a and the user side 122a may differ. Indeed, it is possible that the most recent user key stored on the provider side 120a may be identical to the previous user key stored on the user side 122a. In such an instance, it is desirable to not have the authentication process fail simply because of the delay in updating the user keys on the provider side 120a.

If the third received response is also not successfully verified against the first generated response, a false user alert is produced at 332. This false user alert may represent any of a number of problems, including: 1) the most recent user key stored on the provider side 120a does not match either of the two most recent user keys received at the user side 122a, 2) the user side 122a is not applying the correct algorithm to the challenge and stored user keys, 3) the user side 122a did not receive the correct challenge, or 4) the user side 122a entered an incorrect username and therefore the provider's unique user keys do not match the user's stored user keys. The false user alert is generally indicative of a false user attempting to access the provider system 110a.

At 334, access is denied the user 102a, and at 336, the user side 122a receives an access denied indication. In one embodiment, access may be denied by a web server on the provider side 120a denying access to the browser 240 on the user system 104a. The user 102a may then start the authentication process again. Alternatively, the user 102a may need to contact the provider 108a or the trusted third party 124 in order to verify the user's identity in an alternative way and then re-attempt the authentication process.

If either the first received response or the third received response was successfully verified against the first generated response, then at 338 the provider side 120a verifies the second received response against the second generated response in a manner similar to that described with respect to verification at 328.

If the second received response is not successfully verified against the second generated response, an imposter alert is produced at 340. This imposter alert may represent any of a number of problems, including: 1) the most recent provider key stored on the user side 122a does not match the provider key stored on the provider side 120a, 2) the user side 122a is not applying the correct algorithm to the challenge and stored provider key, or 3) the user 102a entered an incorrect username and therefore the provider's unique provider key does not match the user's stored provider key. The imposter alert is generally indicative of an imposter attempting to impersonate the user security device 106a in accessing the provider system 110a.

At 342, access is denied the user 102a, and at 336, the user side 122a receives an access denied indication. The first user 102a may then start the authentication process again. Alternatively, the user 102a may need to contact the provider 108a or the trusted third party 124 in order to verify the user's identity in an alternative way and then re-attempt the authentication process. In some embodiments, the access denied indication sent to the user via acts 334 or 342 may differ. However, in other embodiments, the user is only informed that access has been denied.

If both of the respective received responses have been verified against the first and second generated responses, the provider side 120a generates a confirmation. In some embodiments, the user side 122a and the provider side 120a may then initiate a session, and the provider side 120a may provide the user 102a with access to the user-requested information. For example, if the provider 108a is a bank, then the user 102a may be provided with account information. Since the user 102a has, at this point, been properly authenticated, the provider side 120a may provide such secret information to the user 102a. However, in other embodiments, the user 102a may also wish to authenticate the provider 108a before sharing private or confidential information with the provider side 120a. In such embodiments, the user side 120a may perform the following.

At 344, the provider side 120a generates a confirmation code based on the first received response and the most recent user key stored on the provider side 120a. In one embodiment, the gatekeeper module 112a generates the confirmation code according to the same algorithm used to generate the first and second responses. In other embodiments, a second, different algorithm is used on the provider side 120a in order to generate the confirmation code.

At 346, the provider side 120a sends the confirmation code, a session page and a new provider key to the user side 122a. In one embodiment, the confirmation code, session page and the new provider key are sent by the provider system 110a via HTTPS. This new provider key may then be used for a subsequent authentication session between the user 102a and the provider 108a. In other embodiments, the provider side 120a may send only the confirmation code and a session page to the user side 122a, and in still other embodiments, the provider side 120a may send just the confirmation code. It may be understood that, as the user 102a has now been authenticated, the session page may comprise a web page with confidential, user-requested information on it.

At 348, the confirmation code, session page and new provider key are received on the user side 122a. In one embodiment, the new provider key may be cached in the user system 104a, awaiting authentication of the provider 108a before storing the new provider key in the memory 256 of the user security device 106a. The confirmation code, session page and new provider key may be received at the user system 104a by the browser 240. Upon receipt, the browser 240 may generate a confirmation code request, prompting the user security device 106a to generate a first confirmation code for verification of the received confirmation code.

At 350, the user side 122a generates a first confirmation code based on the first response originally produced on the user side 122a and the most recent user key stored on the memory 256 of the user security device 106a. In one embodiment, a driver or application program associated with the user security device 106a may be used to generate the first confirmation code based on the first response and the most recent user key. This application program and/or driver may have been received from the trusted third party 124 at an earlier time, and preferably comprise the same algorithm used earlier to produce the first response. In other embodiments, a second, different algorithm may be used to generate the first confirmation code. The application program and/or driver may be stored on the memory 256 of the user security device 106a, or may be stored on other media, such as the hard disks 220, optical disks 226 or magnetic disks 228 readable by the user system 104a.

In another embodiment, the user security device 106a may include software or firmware executable by the user security device 106a that includes the algorithm for generating the first confirmation code. In this embodiment, a processor in the user security device 106a may execute the algorithm, and the first confirmation code may then be passed on to the user system 104a.

At 352, the user side 122a generates a second confirmation code based on the first response and the previous user key. The second confirmation code may be produced in a manner similar to that described with reference to the first confirmation code.

At 354, the user side 122a verifies the received confirmation code against the first generated confirmation code. In one embodiment, the user security device 106a generates the first and second confirmation codes and then forwards them to the user system 104a for verification. The received confirmation code may be successfully verified against the first generated confirmation code if the two confirmation codes are identical. However, in other embodiments, other methods for verifying the confirmation codes may be used.

If the received confirmation code has not been successfully verified against the first generated confirmation code, at 356 the user side 122a verifies the received confirmation code against the second generated confirmation code in a manner similar to that described with reference to the first generated confirmation code.

If the received confirmation code is also not successfully verified against the second generated confirmation code, the user side 122a produces a phishing alert at 358. This phishing alert may represent any of a number of problems, including that an attempt is being made to impersonate the provider system 110a. In one embodiment, after a phishing alert, the new provider key will not be stored on the memory 256 of the user security device 106a, and the session between the user 102a and the provider 108a will be terminated.

If either the received confirmation code is successfully verified against either the first or the second generated confirmation codes, then at 360 the user side 122a establishes a session with the provider side 120a. More particularly, a session may be established between the user system 104a and the provider system 110a. At this point, the user 102a and the provider 108a are properly authenticated, and the exchange of private information may take place in either direction. At 362, the user side 122a stores the new provider key in the memory 256 of the user security device 106a, so that this new provider key may be used in a subsequent authentication session.

Although the acts of the above described authentication method are presented in a particular order, many of the acts need not be performed in this order. For example, some of the acts may be performed out of order or simultaneously. Moreover, more or fewer acts may be used to accomplish authentication, and, in certain embodiments, only a selected portion of the acts presented may be implemented.

In addition, the user security device 106a described herein may be used to facilitate access to a plurality of providers 108, and need not be used solely for a single provider 108a. Thus, the user may carry a single USB memory device, for example, for the authentication processes used at all of the user's service providers. In one embodiment, the user need only enter a single password associated with the user security device 106a and can thereby access all of these service providers. The user security device 106a may also make it easier to determine the security of the user's accounts. For example, it is more easily determined that the user security device 106a is missing or stolen than that the user's passwords to individual accounts have been compromised.

### Discussion of a Method of Registration According to One Embodiment

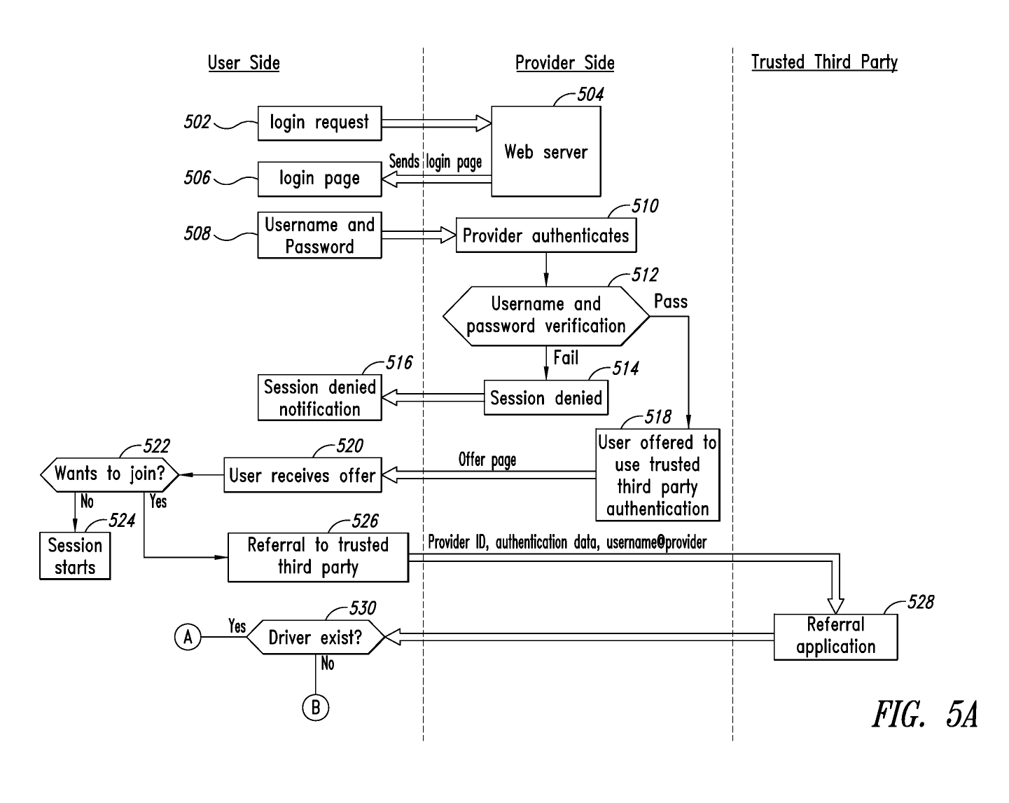

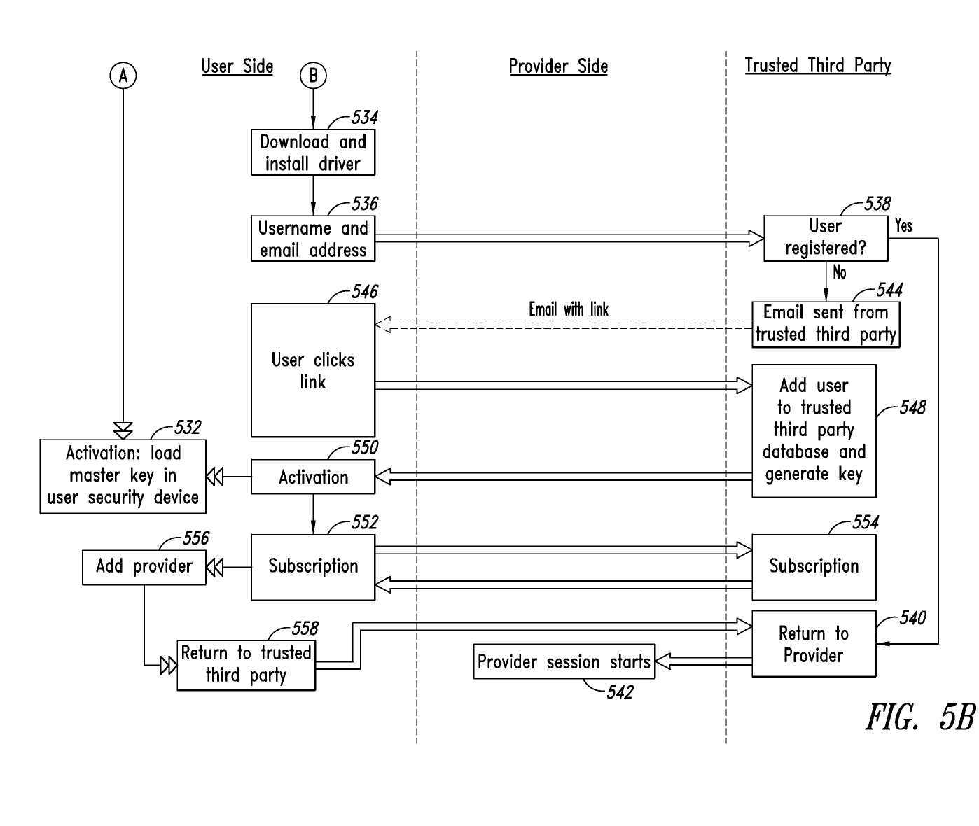

FIGS. 5A and 5B depict a flow diagram of a method for initially registering a user and a provider with a trusted third party according to one illustrated embodiment. In one embodiment, this initial registration is completed before the authentication method described above with reference to FIGS. 3 and 4 is performed. This registration method will be discussed in the context of the user 102a, the provider 108a and the trusted third party 124. However, it may be understood that the acts disclosed herein may also be executed in different computing environments in accordance with the method. In addition, the default network protocol used below is HTTPS, although other network protocols may also be used to accomplish the initial registration.

The method begins at 502, when the user side 122a sends a login request to the provider side 120a. In one embodiment, a user directs a browser 240 on the user system 104a to a web page hosted by the provider system 110a. This web page may include a login option, among other information. In another embodiment, another network protocol may be used by the user system 104a to make contact with the provider side 120a to attempt a login.

At 504, the provider side 120a receives the login request from the user side 122a. In one embodiment, the provider system 110a includes a web server (as illustrated), which receives the web page request from the user system 104a. In alternative embodiments, the gatekeeper module 112a, or another computing device on the provider side 120a may receive the login request sent at 502. The provider side 120a then sends a login page to the user side 122a. The login page may comprise any markup language, such as HTML or XML. Any of a number of scripting and/or programming languages may be used to generate such a login page.

At 506, the user side 122a receives the login page, which may include a request for the user's username and password. At 508, the user may enter a username and password using the keyboard 242 or mouse 244 of the user system 104a. Alternatively, the user system 104a may use biometric identification to authenticate the user, such as fingerprints, retinal scans, etc. This information is then returned to the provider side 120a for authentication at 510.

At 512, the provider side 120a verifies that the username and password are a valid combination. In one embodiment, for example, the provider system 110a searches through a database of usernames until it finds the username returned by the user side 122a. Once found, the provider system 110a performs a comparison between the password returned by the user side 122a and the password stored on the provider side 120a that is associated with the entered username.

If the username is not found, or the passwords do not match, then the session is denied at 514. A message to that effect is forwarded to the user side 122a at 516, and the user may be given another chance to enter a username and password. In one embodiment, for example, if the username does not match any usernames stored on the provider side 120a, the browser 240 may display a web page on the user system 104a indicating that “No username match was found.”

At 518, if the username and password are successfully verified, the provider side 120a prepares a web page presenting the user with the opportunity to use a third party authentication scheme. At 520, the user receives this offer and determines whether he or she wishes to join at 522. In one embodiment, at 520, along with the offer to use the authentication scheme, the user may be given further information regarding the requirements for using the authentication scheme as well as cost information. In addition, the provider 108a may choose to provide certain incentives to the user to use the authentication scheme. For example, if the provider 108a is an online storefront, the provider 108a may place certain limitations on the user's potential spending within a certain time period (e.g., to prevent fraud), but may raise those limitations with improved security.

At 524, if the user opts not to join, a normal session may be initiated between the user 102a and the provider 108a. However, if the user does choose to join, at 526 the user side 122a communicates directly with the trusted third party 124, sending a provider identifier, authentication data, and the user's username at the provider.

At 528, the trusted third party 124 receives the user's application to use its authentication scheme, processes the application, and causes the user side 122a to determine whether or not a trusted third party driver already exists on the user system 104a. The trusted third party driver may serve a number of purposes on the user side 122a. In one embodiment, the trusted third party driver enables secure communication between the user system 104a and the user security device 106a. In another embodiment, the trusted third party driver may load firmware onto the user security device 106a, enabling the user security device 106a to perform certain algorithms used in the above-described authentication method. In yet another embodiment, the trusted third party driver may have application programs associated therewith that enable the user system 104a to perform certain algorithms used in the above-described authentication method.

At 530, the user side 122a determines whether or not the trusted third party driver exists. At 532, if the trusted third party driver does exist, the user security device 106a is activated, as described below. Otherwise, at 534, the trusted third party driver is downloaded and installed from the trusted third party 124 itself, or from another website or other source. For example, in some embodiments, the user security device 106a may be sold with a trusted third party driver, and upon prompting, the user may be required to load the trusted third party driver from a packaged CD.

At 536, after the trusted third party driver has been installed, the user forwards a username and email address to the trusted third party 124 for registration. If, at 538, the trusted third party 124 determines that the user has already registered, the user is referred back to the provider system 110a at 540, and a session is begun at 542.

If, on the other hand, the user has not yet registered, then, at 544, an email is sent from the trusted third party 124 to the user 102a with a link. By having the user click on this link at 546, the registration method confirms the validity of the email address for the user. However, in other embodiments, no link need be sent via email. With the email address of the newly registered user confirmed, the trusted third party 124 may then add the user to its database and generate a master key at 548.

At 550, the trusted third party 124 informs the user side 122a of the successful activation and forwards the generated master key. In one embodiment, at 532, this master key is then loaded onto the user security device 106a. The master key may be used in one embodiment for an initial authentication between the user 102a and the provider 108a. For example, as set forth above, the authentication method may usually require two keys (a user key and a provider key), but at the first authentication session the user security device 106a may not have two keys stored thereon. To enable authentication for this first session, the user 102a may authenticate using only the master key, and then use the method described above for subsequent authentication sessions requiring two keys.

At 552 and 554, the user side 122a and the trusted third party 124 may perform a subscription process. During this process, in one embodiment, the user may specify certain levels of security for his or her new account. For example, the user may require that the user keys be changed daily, weekly, monthly, etc. In another embodiment, the subscription process may include associating providers with the user on the user security device 106a and on a database at the trusted third party 124, as shown at 556. Thus, for example, when the trusted third party 124 sends new user keys to its provider network, it forwards the appropriate user keys to each respective provider.

At 558, with the subscription process complete, the trusted third party 124 returns the user side 122a to the provider side 120a, and the session begins at 542.

Some of the methods discussed above employ the generation of random numbers or values and some of the structures discussed above refer to random number generators (RNGs). While referred to herein and in the claims as being a random number or value and/or an RNG, such terms encompass numbers and values as well as generators that are not truly random in the mathematical sense, such as those sometimes referred to as being pseudo-random. In some embodiments, the random number generator may take the form of a discrete analog or digital component. In other embodiments the RNG may take the form of a controller such as a microcontroller, microprocessor, digital signal processor, application specific integrated circuit or field programmable gate array executing suitable instructions to provide an RNG function.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information can be stored on any computer readable medium for use by or in connection with any computer and/or processor related system or method. In the context of this document, a memory is a computer readable medium that is an electronic, magnetic, optical, or other physical device or means that contains or stores a computer and/or processor program. Logic and/or the information can be embodied in any computer readable medium for use by or in connection with an instruction execution system, apparatus, or device, such as a computer-based system, processor-containing system, or other system that can fetch the instructions from the instruction execution system, apparatus, or device and execute the instructions associated with logic and/or information. In the context of this specification, a “computer readable medium” can be any means that can store, communicate, propagate, or transport the program associated with logic and/or information for use by or in connection with the instruction execution system, apparatus, and/or device. The computer readable medium can be, for example, but is not limited to, an electronic, magnetic, optical, electromagnetic, infrared, or semiconductor system, apparatus, device, or propagation medium. More specific examples (a nonexhaustive list) of the computer readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

In addition, those skilled in the art will appreciate that certain mechanisms taught herein are capable of being distributed as a program product in a variety of forms, and that an illustrative embodiment applies equally regardless of the particular type of signal-bearing media used to actually carry out the distribution. Examples of signal-bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. From the foregoing it will be appreciated that, although specific embodiments have been described herein for purposes of illustration, various modifications may be made without deviating from the spirit and scope of the teachings. Accordingly, the claims are not limited by the disclosed embodiments.

We/I claim:

1. A method of authentication between a first party and a second party, the method comprising:
generating a challenge to a first party system;
receiving a first response via the first party system, the first received response produced on a first party side of a network connection, the first received response based on the challenge and a most recent first party key stored on a memory of a first party security device communicatively coupled to the first party system;
receiving a second response via the first party system, the second received response produced on the first party side of the network connection, the second received response based on the challenge and a second party key stored on the memory of the first party security device, the second party key provided to the first party security device from a second party side of the network connection;
generating a first response based on the challenge and a most recent first party key stored on the second party side of the network connection;
generating a second response based on the challenge and a second party key stored on the second party side of the network connection;
verifying the first received response against the first generated response;
verifying the second received response against the second generated response; and
generating a confirmation in response to a successful verification of both the first and the second received responses.

2. The method of claim 1, further comprising:
producing an imposter alert in response to a successful verification of the first received response and an unsuccessful verification of the second received response, the imposter alert indicative of an imposter attempting to impersonate the first party security device in accessing a second party system.

3. The method of claim 1, further comprising:
receiving a third response via the first party system, the third received response produced on the first party side of the network connection, the third received response based on the challenge and a previous first party key stored on the memory of the first party security device;
in response to an unsuccessful verification of the first received response, verifying the third received response against the first generated response; and
generating a confirmation in response to a successful verification of both the second and the third received responses.

4. The method of claim 3, further comprising:
producing a false user alert in response to an unsuccessful verification of the first received response and an unsuccessful verification of the third received response, the false user alert indicative of a false user attempting to access a second party system.

5. The method of claim 4 wherein the false user alert causes a denying of access by a web server on the second party side of the network connection to a web browser on the first party side of the network connection.

6. The method of claim 3 wherein the first, the second and the third received responses are received together.

7. The method of claim 1 wherein generating the challenge includes generating a random challenge.

8. The method of claim 1 wherein generating the challenge includes generating a random challenge in response to a login request received from the first party system at a second party system on the second party side of the network connection.

9. The method of claim 1 wherein generating the confirmation includes generating a confirmation code based on the first received response and the most recent first party key stored on the second party side of the network connection.

10. The method of claim 1, further comprising:
receiving the most recent first party key stored on the second party side of the network connection from a trusted third party system.

11. The method of claim 1 wherein the most recent first party key stored on the memory of the first party security device is received from a trusted third party system.

12. The method of claim 11 wherein the first party security device is a portable memory device.

13. The method of claim 12 wherein the portable memory device is a Universal Serial Bus memory device.

14. The method of claim 1, wherein a gatekeeper module on the second party side of the network connection performs the generating of the challenge, the generating of the first and the second generated responses and the verifying of the first and the second received responses.

15. The method of claim 1, further comprising:
receiving a login request from the first party system at a second party system on the second party side of the network connection;
prompting a gatekeeper module to generate the challenge;
receiving the challenge from the gatekeeper module at the second party system;
creating a login page including the challenge and a second party identifier; and
sending the login page to the first party system.

16. The method of claim 1, further comprising:
generating a new second party key on the second party side of the network connection; and
providing the new second party key to the first party security device.

17. A method of authentication between a first party and a second party, the method comprising:
receiving a challenge at a first party system from a second party side of a network connection;
producing a first response to the challenge on a first party side of the network connection, the first response based on the challenge and a most recent first party key stored on a memory of a first party security device communicatively coupled to the first party system;
producing a second response to the challenge on the first party side of the network connection, the second response based on the challenge and a second party key stored on the memory of the first party security device, the second party key provided to the first party security device from the second party side of the network connection;
receiving a confirmation code from the second party side of the network connection, the received confirmation code based on the first response and a most recent first party key stored on the second party side of the network connection as provided by a trusted third party;
generating a first confirmation code based on the first response and the most recent first party key stored on the memory of the first party security device; and
verifying the received confirmation code against the first generated confirmation code.

18. The method of claim 17, further comprising:
establishing a session between a second party system on the second party side of the network connection and the first party system on the first party side of the network connection in response to a successful verification of the received confirmation code against the first generated confirmation code.

19. The method of claim 17, further comprising:
generating a second confirmation code based on the first response and a previous first party key stored on the memory of the first party security device; and
in response to an unsuccessful verification of the received confirmation code against the first generated confirmation code, verifying the received confirmation code against the second generated confirmation code.

20. The method of claim 19, further comprising:
establishing a session between a second party system on the second party side of the network connection and the first party system on the first party side of the network connection in response to a successful verification of the received confirmation code against the second generated confirmation code.

21. The method of claim 19, further comprising:
producing a phishing alert in response to an unsuccessful verification of the received confirmation code against both the first and the second generated confirmation codes, the phishing alert indicative of an attempt to impersonate a second party system.

22. The method of claim 17 wherein the first party security device is communicatively coupled to the first party system on the first party side of the network connection.

23. The method of claim 17 wherein the generating of the first generated confirmation code is in response to a confirmation code request from the first party system on the first party side of the network connection, wherein the confirmation code request is indicative of a receipt of the received confirmation code at the first party system via a second party system on the second party side of the network connection.

24. The method of claim 19 wherein the generating of the second generated confirmation code is in response to a confirmation code request from the first party system on the first party side of the network connection, wherein the confirmation code request is indicative of a receipt of the received confirmation code at the first party system via a second party system on the second party side of the network connection.

25. The method of claim 17, further comprising:
storing the second party key in the memory of the first party security device.

26. The method of claim 17, further comprising:
from time to time receiving a new first party key from the trusted third party; and
storing the new first party key in the memory of the first party security device as the most recent first party key.

27. The method of claim 17 wherein receiving the received confirmation code from the second party side of the network connection includes receiving a session page including the received confirmation code and a new second party key from a second party system on the second party side of the network connection.

28. The method of claim 17, further comprising:
providing the first and the second responses to the challenge from the first party security device to the first party system on the first party side of the network connection.

29. The method of claim 28, further comprising:
providing the first and the second responses to the challenge from the first party system to a second party system on the second party side of the network connection.

30. The method of claim 17, further comprising:
producing a third response to the challenge on the first party side of the network connection, the third response based on the challenge and a previous first party key stored on the memory of the first party security device.

31. The method of claim 30, further comprising:
providing the third response to the challenge from the first party security device to the first party system on the first party side of the network connection; and
providing the third response to the challenge from the first party system to a second party system on the second party side of the network connection along with the first and the second responses.

32. The method of claim 17 wherein receiving the challenge at the first party system from the second party side includes receiving the challenge from a gatekeeper module via a second party system on the second party side of the network connection.

33. The method of claim 17 wherein receiving the challenge at the first party system from the second party side includes receiving the challenge from a gatekeeper module via a second party system on the second party side of the network connection along with a second party identifier.

34. The method of claim 17 wherein receiving the challenge at the first party system from the second party side includes receiving the challenge via a second party system on the second party side of the network connection.

35. The method of claim 34 wherein producing the second response to the challenge includes producing the second response to the challenge based on the challenge and the second party key provided to the first party security device via the second party system on the second party side of the network connection.

36. The method of claim 35 wherein receiving the received confirmation code from the second party side of the network connection includes receiving the received confirmation code from the second party system on the second party side of the network connection.

37. A computer-readable medium that stores instructions that cause a computer to perform authentication between a first party and a second party, by:
generating a challenge to a first party system;
receiving a first response via the first party system, the first received response produced on a first party side of a network connection, the first received response based on the challenge and a most recent first party key stored on a memory of a first party security device communicatively coupled to the first party system;
receiving a second response via the first party system, the second received response produced on the first party side of the network connection, the second received response based on the challenge and a second party key stored on the memory of the first party security device, the second party key provided to the first party security device from a second party side of the network connection;
generating a first response based on the challenge and a most recent first party key stored on the second party side of the network connection;
generating a second response based on the challenge and a second party key stored on the second party side of the network connection;
verifying the first received response against the first generated response;
verifying the second received response against the second generated response; and
generating a confirmation in response to a successful verification of both the first and the second received responses.

38. The computer-readable medium of claim 37 where the instructions cause the computer to perform authentication, further by:
producing an imposter alert in response to a successful verification of the first received response and an unsuccessful verification of the second received response, the imposter alert indicative of an imposter attempting to impersonate the first party security device in accessing a second party system.

39. The computer-readable medium of claim 37 where the instructions cause the computer to perform authentication, further by:
receiving a third response via the first party system, the third received response produced on the first party side of the network connection, the third received response based on the challenge and a previous first party key stored on the memory of the first party security device;
in response to an unsuccessful verification of the first received response, verifying the third received response against the first generated response; and
generating a confirmation in response to a successful verification of both the second and the third received responses.

40. The computer-readable medium of claim 39 where the instructions cause the computer to perform authentication, further by:
producing a false user alert in response to an unsuccessful verification of the first received response and an unsuccessful verification of the third received response, the false user alert indicative of a false user attempting to access a second party system.

41. The computer-readable medium of claim 37 where the instructions cause the computer to perform authentication, further by:
receiving the most recent first party key stored on the second party side of the network connection from a trusted third party system.

42. The computer-readable medium of claim 37 where the instructions cause the computer to perform authentication, further by:
receiving a login request from the first party system at a second party system on the second party side of the network connection;
prompting a gatekeeper module to generate the challenge;
receiving the challenge from the gatekeeper module at the second party system;
creating a login page including the challenge and a second party identifier; and
sending the login page to the first party system.

43. A computer-readable medium that stores instructions that cause a computer to perform authentication between a first party and a second party, by:
receiving a challenge at a first party system from a second party side of a network connection;
producing a first response to the challenge on a first party side of the network connection, the first response based on the challenge and a most recent first party key stored on a memory of a first party security device;
producing a second response to the challenge on the first party side of the network connection, the second response based on the challenge and a second party key stored on the memory of the first party security device, the second party key provided to the first party security device from the second party side of the network connection;
receiving a confirmation code from the second party side of the network connection, the received confirmation code based on the first response and a most recent first party key stored on the second party side of the network connection as provided by a trusted third party;
generating a first confirmation code based on the first response and the most recent first party key stored on the memory of the first party security device; and
verifying the received confirmation code against the first generated confirmation code.

44. The computer-readable medium of claim 43 where the instructions cause the computer to perform authentication, further by:
establishing a session between a second party system on the second party side of the network connection and the first party system on the first party side of the network connection in response to a successful verification of the received confirmation code against the first generated confirmation code.

45. The computer-readable medium of claim 43 where the instructions cause the computer to perform authentication, further by:
generating a second confirmation code based on the first response and a previous first party key stored on the memory of the first party security device; and
in response to an unsuccessful verification of the received confirmation code against the first generated confirmation code, verifying the received confirmation code against the second generated confirmation code.

46. The computer-readable medium of claim 45 where the instructions cause the computer to perform authentication, further by:
establishing a session between a second party system on the second party side of the network connection and the first party system on the first party side of the network connection in response to a successful verification of the received confirmation code against the second generated confirmation code.

47. The computer-readable medium of claim 45 where the instructions cause the computer to perform authentication, further by:
producing a phishing alert in response to an unsuccessful verification of the received confirmation code against both the first and the second generated confirmation codes, the phishing alert indicative of an attempt to impersonate a second party system.

48. The computer-readable medium of claim 43 where the instructions cause the computer to perform authentication, further by:
storing the second party key in the memory of the first party security device.

49. The computer-readable medium of claim 43 where the instructions cause the computer to perform authentication, further by:
from time to time receiving a new first party key from the trusted third party; and
storing the new first party key to the memory of the first party security device as the most recent first party key.

50. The computer-readable medium of claim 43 where the instructions cause the computer to perform authentication, further by:
producing a third response to the challenge on the first party side of the network connection, the third response based on the challenge and a previous first party key stored on the memory of the first party security device.

51. The computer-readable medium of claim 50 where the instructions cause the computer to perform authentication, further by:
providing the third response to the challenge from the first party security device to the first party system on the first party side of the network connection; and
providing the third response to the challenge from the first party system to a second party system on the second party side of the network connection along with the first and the second responses.

52. A system that performs authentication between a first party and a second party, the system comprising:
at least one processor that executes instructions; and
a computer-readable memory that stores instructions that cause the at least one processor to perform authentication, by:
generating a challenge to a first party system;
receiving a first response via the first party system, the first received response produced on a first party side of a network connection, the first received response based on the challenge and a most recent first party key stored on a memory of a first party security device communicatively coupled to the first party system;
receiving a second response via the first party system, the second received response produced on the first party side of the network connection, the second received response based on the challenge and a second party key stored on the memory of the first party security device, the second party key provided to the first party security device from a second party side of the network connection;
generating a first response based on the challenge and a most recent first party key stored on the second party side of the network connection;
generating a second response based on the challenge and a second party key stored on the second party side of the network connection;
verifying the first received response against the first generated response;
verifying the second received response against the second generated response; and
generating a confirmation in response to a successful verification of both the first and the second received responses.

53. The system of claim 52 wherein the instructions cause the at least one processor to perform authentication further by:
receiving a third response via the first party system, the third received response produced on the first party side of the network connection, the third received response based on the challenge and a previous first party key stored on the memory of the first party security device;
in response to an unsuccessful verification of the first received response, verifying the third received response against the first generated response; and
generating a confirmation in response to a successful verification of both the second and the third received responses.

54. The system of claim 53 wherein the instructions cause the at least one processor to perform authentication further by:
producing an imposter alert in response to a successful verification of the first received response and an unsuccessful verification of the second received response, the imposter alert indicative of an imposter attempting to impersonate the first party security device in accessing a second party system; and
producing a false user alert in response to an unsuccessful verification of the first received response and an unsuccessful verification of the third received response, the false user alert indicative of a false user attempting to access the second party system.
